(19) United States
(12) Patent Application Publication
(10) Pub. No.: US 2010/0047058 A1
(43) Pub. Date: Feb. 25, 2010

(54) SYSTEM AND METHOD FOR TEMPERATURE SENSING IN TURBINES

(75) Inventors: Chayan Mitra, Bangalore (IN); Ayan Banerjee, Bangalore (IN); Norman Arnold Turnquist, Sloansville, NY (US); Danian Zheng, Simpsonville, SC (US); Sandip Maity, Bangalore (IN); Roy Paul Swintek, Altamont, NY (US)

Correspondence Address: GENERAL ELECTRIC COMPANY (PCPI);C/O FLETCHER YODER, P. O. BOX 692289, HOUSTON, TX, 77269-2289, US

(73) Assignee: General Electric Company, a New York Corporation, Schenectady, NY (US)

(21) Appl. No.: 12/198,026

(22) Filed: Aug. 25, 2008

(51) Int. Cl. F01D 25/00; G01K 11/00; G01K 13/08; G01K 15/00

(52) U.S. Cl. 415/118; 374/161; 374/1; 374/E15.001; 374/E11.001; 374/E13.01

(57) ABSTRACT

A method for measuring temperature of a rotating body such as a steam turbine is provided. The method includes striking a light beam onto the rotating body onto the rotating body and measuring a reflectance of the light beam from the rotating body. The method further includes obtaining a temperature of the rotating body based upon the measured reflectance.

### BACKGROUND

The invention relates generally to turbine engines, and more particularly to monitoring temperature in a turbine component by an optical technique.

Temperature sensors are commonly used to measure temperature of an object via desirable thermal contact with a surface of the object. The sensors and the object reach thermal equilibrium after a certain period of time enabling measurement of temperature. The thermal equilibrium of the sensor depends on factors, such as the quality of thermal contacts and the degree of thermal isolation of the sensor and the object from a surrounding environment. Thermocouples, thermistors or resistance temperature detectors are typical contact-based temperature measurement devices, wherein epoxy is used for thermal contact of the sensor with the surface of the object. If the thermal contact with the surface of the object is imperfect, the equilibrium temperature of the sensor will be measurably below that of the surface.

A major challenge in temperature measurement is measuring a temperature of a surface of a rotating object (e.g. a steam turbine rotor). Thermocouples are not desirable for such an application, since it is difficult to output an electrical signal from the rotating object. Infrared radiometry is a typical, non-contact technique for measuring temperature of the rotating object by observing infrared energy emitted from the surface of the rotating object. However, such a technique requires that an emissivity of the surface of the rotating object, such as the steam turbine, be known with high accuracy.

### BRIEF DESCRIPTION

In accordance with one exemplary embodiment of the present invention, a method for measuring temperature of a rotating body is provided. The method includes striking a light beam onto the rotating body and measuring a reflectance of the light beam from the rotating body. The method further includes obtaining a temperature of the rotating body based upon the measured reflectance.

In accordance with another exemplary embodiment of the present invention, a turbine having a temperature measurement system is provided. The temperature measurement system includes a light source to emit a light beam onto a rotor of the turbine. The system also has a light detector for detecting reflectance of the light beam from the rotor. The system further includes a processing circuitry to obtain temperature based on the reflectance of the light beam.

In accordance with yet another exemplary embodiment of the present invention, a system having a computer-readable medium comprising code for determining temperature as a function of reflectance measurements from a light beam directed toward and reflected from an object is provided.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a perspective view of a turbine monitored by a temperature measurement system in accordance with an embodiment of the present invention;

FIG. 2 is a perspective view of a rotor of a steam turbine monitored by a temperature measurement system in accordance with an embodiment of the present invention;

FIG. 3 is a block diagram of a temperature measurement system in accordance with an embodiment of the present invention;

FIG. 4 is a block diagram of a temperature measurement system with a calibration setup in accordance with an embodiment of the present invention;

FIG. 5 is a block diagram of a temperature measurement system used in a turbine in accordance with an embodiment of the present invention;

FIG. 6 is a graphical illustration of reflectance versus temperature for an aluminum body;

FIG. 7 is an illustration of light intensity measurement in a scatter region;

FIG. 8 is a graphical illustration of reflectance versus temperature for an unpolished turbine blade;

FIG. 9 is a graphical illustration of reflectance versus temperature for a polished turbine blade;

FIG. 10 is a graphical illustration of reflectance versus angle of incidence for a polished aluminum block;

FIG. 11 is a flow chart representing steps in an exemplary calibration process in accordance with an embodiment of the present invention;

FIG. 12 is a flow chart representing steps of temperature measurement of a metal surface in accordance with an embodiment of the present invention;

FIG. 13 is a flow chart representing steps for monitoring fouling of the window in accordance with an embodiment of the present invention; and

FIG. 14 is a flow chart representing steps of temperature measurement used for monitoring blade fouling in accordance with an embodiment of the present invention.

### DETAILED DESCRIPTION OF THE INVENTION

As discussed in detail below, embodiments of the present invention provides a method for measuring temperature of a rotating body and a turbine with a temperature measurement system. The invention also provides a system with a computer-readable medium having code for determining temperatures. The temperature measurement is done based on measuring change in reflectance of a light beam from a heated body. The variation of reflected light beam with temperature is calibrated to determine the absolute temperature of the metal. Although the present discussion focuses on a turbine, the system is applicable to any rotating machine, such as a compressor or a generator.

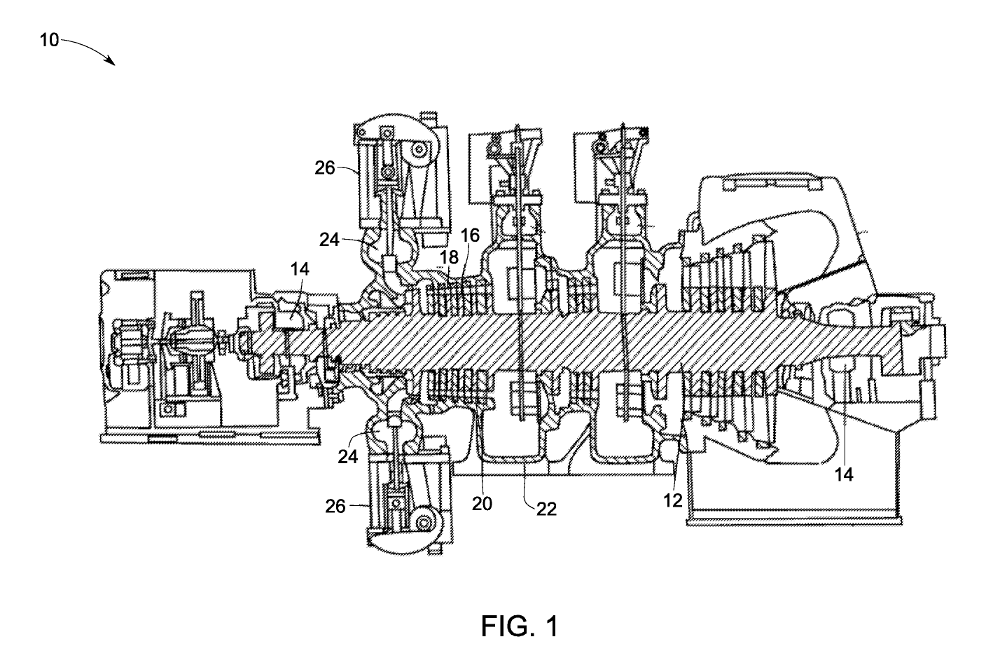

FIG. 1 is a perspective view of an exemplary rotating machine, such as a steam turbine 10, incorporating a temperature measurement system in accordance with an embodiment of the present invention. The turbine 10 includes a rotor shaft 12 extending through the turbine 10 and rotatably supported at each end by bearing supports 14. A plurality of rows of turbine blades 16 are coupled to the shaft 12, and a plurality of stationary turbine nozzles 18 are positioned between adjacent rows of turbine blades 16. Turbine blades 16 are coupled to the turbine shaft 12, and turbine nozzles 18 are coupled to support members or nozzle diaphragms 20 attached to a housing or shroud 22 surrounding turbine blades 16 and nozzles 18. Steam inlet ports 24 channel steam supplied from a steam source into the turbine 10, and a main steam control valve 26 controls the flow of steam into the turbine 10. In operation, steam is directed through nozzles 18 to impact blades 16, which causes blades 16 to rotate with the rotor shaft 12. There is a relatively small clearance between the blades 16 and the shroud 22 to prevent excessive leakage of the working fluid, between the blades 16 and the shroud 22.

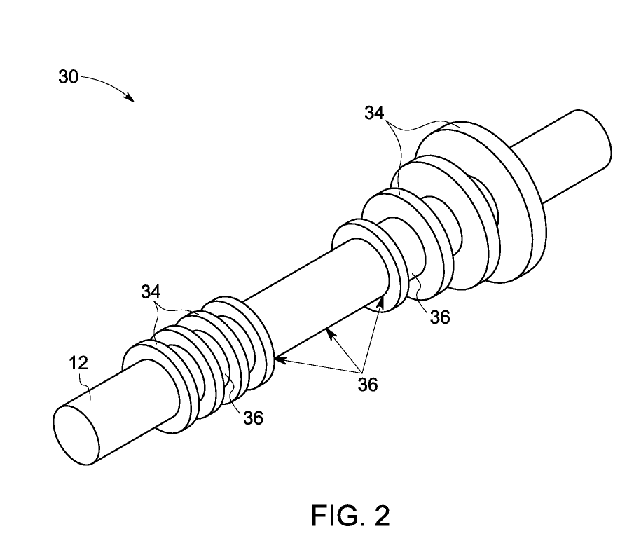

FIG. 2 is an exemplary view of a multiple stage rotor 30 of the turbine 10 incorporating a temperature measurement system in accordance with an embodiment of the present invention. The rotor 30 generally includes a rotor shaft 12 on which a number of wheels 34 are either mounted to or formed integrally with the shaft 12. Each wheel 34 is adapted to secure a number of buckets or blades (not shown). Within the turbine, the series of wheels 34 form stages between stationary blades or nozzles. As described earlier, the fluid passing through the rotor stages performs work on the wheels 34, which is transmitted through the shaft 12 to a suitable load, such as an electrical generator (not shown). The rotor 30 operates at high temperatures of up to approximately 1200 degrees F. for a steam turbine, and greater than 2000 degrees F. in a gas turbine. These high temperatures can cause failure of various components of the rotor 30 unless the components are protected from heat. Thus, accurate measurement of temperature is important. For instance, FIG. 2 shows locations 36 on the rotor 30 of a turbine where temperature measurement is desirable.

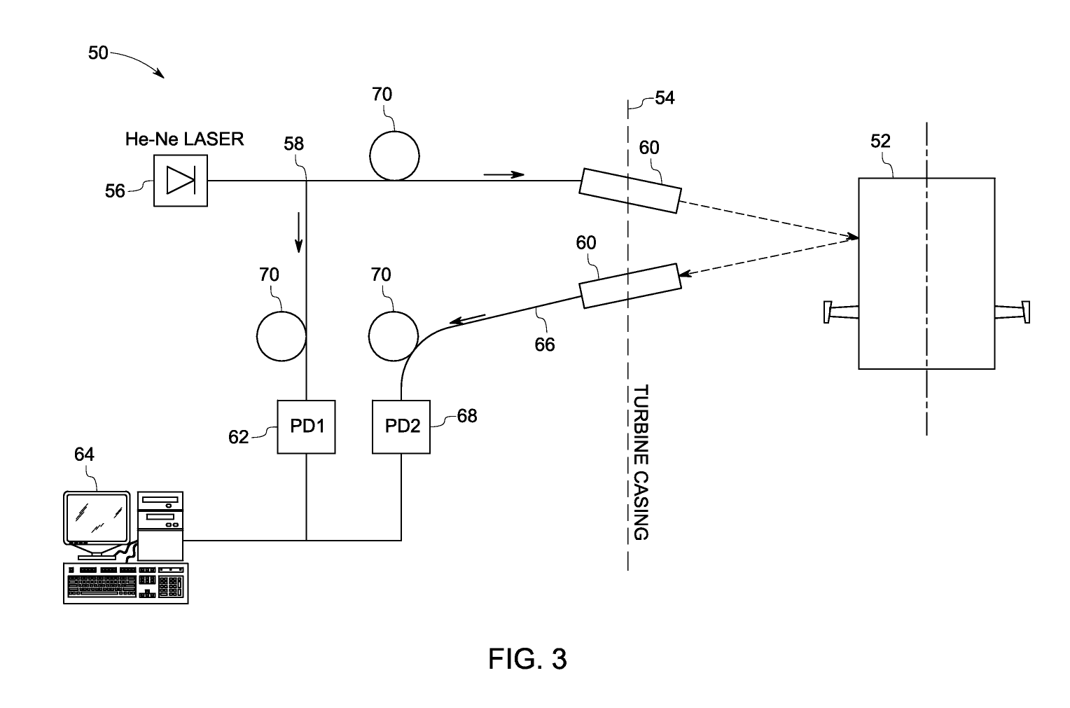

FIG. 3 is a perspective view of a temperature measurement system 50 in accordance with an embodiment of the present invention. As discussed in detail below, the system 50 is configured to measure reflectance, and determine temperature based on the reflectance, in a non-intrusive manner particularly well suited for moving objects. Thus, the system 50 can obtain temperature measurements without directly interfacing with the moving objects. The rotor surface 52 of which temperature is to be measured is enclosed inside a turbine casing 54. A laser beam 58 is incident or focused onto the rotor surface 52 by a laser 56 through a turbine casing window 60. The laser beam 58 is also captured by a first photodiode 62 and passed to a processing circuitry 64. The processing circuitry 64 may include a processor, memory, and associated circuitry, e.g., a computer system. The reflected beam 66 from the rotor surface 52 is captured by a second photodiode 68 through turbine casing window 60. The second photodiode 68 then transmits the reflected beam 66 to the processing circuitry 64. The reflected beam 66 is normalized with respect to the laser beam or the reference beam 58 by the processing circuitry 64. This is necessary to mitigate any changes in the reflected beam 66 due to fluctuations in the laser beam 58. For example, if the laser beam power changes from 900 mW to 1 W, it may result in error of 12% in temperature measurement. In one embodiment, measuring the reflectance of the light beam comprises modulating a light source or a laser directed at the rotating body (e.g., rotor surface 52) and demodulating the reflected light at a same frequency. The second photo diode 68 may capture a white noise and affect the temperature measurement. For example, if the actual reflectance is 4 mV and the photo diode captures noise of 100 μ V on top of that, then the temperature reading may show error of 2 to 3° C. Modulating the laser beam and demodulating the reflected beam at the same frequency can mitigate the white noise to a certain extent. In other words, it significantly improves the signal to noise ratio. Fiber optical couplers 70 used in the system are optical fiber devices with one or more input fibers and one or several output fibers. Light from an input fiber can appear at one or more outputs, with the power distribution potentially depending on the wavelength and polarization. The processing circuitry 64 determines the temperature of the rotor surface 52 by comparing the reading of the second photo diode 68 with a data stored into the memory of the processing circuitry. The stored data is obtained from calibration of the photodiode 68 with a temperature measurement instrument such as thermocouple. The processing circuitry then displays temperature of the rotor of the turbine.

In one embodiment, the processing circuitry 64 determines the temperature of the rotor surface based on a relationship between the temperature and the measured reflectance. One exemplary relationship between temperature of the rotor and the measured reflectance is given by following equation:

$$\frac{R ( T ) - R ( {T}_{0} )}{R ( {T}_{0} )} = {C}_{1} ( T - {T}_{0} ) + \frac{{C}_{2}}{2} {( T - {T}_{0} )}^{2} ; \qquad ( 1 )$$

Where R is optical reflectance, T₀ is the room temperature or reference temperature, and T is the present surface temperature to be measured. C₁ and C₂ are two coefficients given by following equations:

C₁=1/[R(T₀)]dR/dT|_{T}_{₀} (2);

C₂=1/[R(T₀)]d²R/dT²|_{T}_{₀} (3).

In practice, the coefficients C₁ and C₂ are determined based upon a trend line equation generated from the plot of temperature versus reflectance. Equation (1) may further be expanded, if the relationship between temperature and reflectance needs to be a third or a fourth order polynomial.

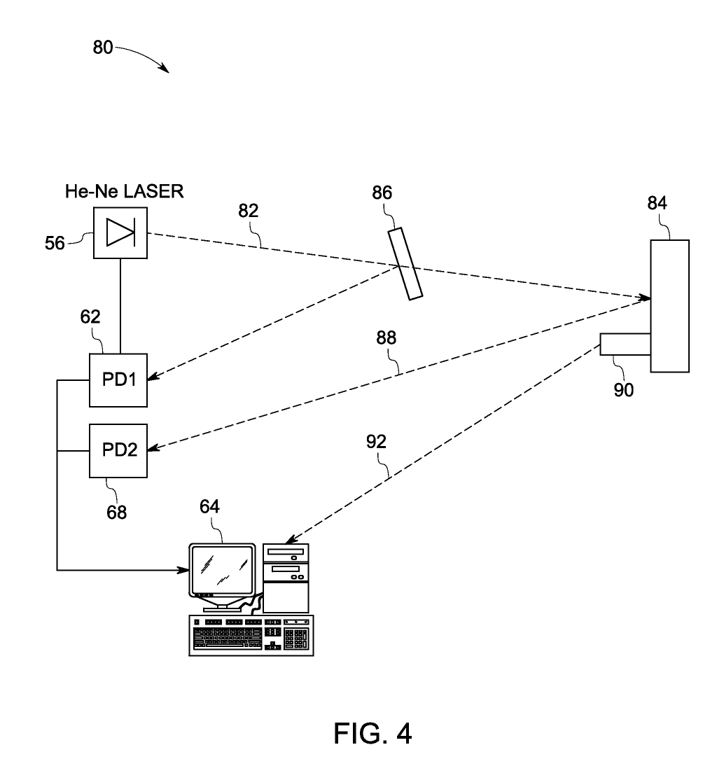

FIG. 4 is a block diagram of the temperature measurement system with a calibration setup 80 in accordance with an embodiment of the present invention. The system 80 is similar to the system 50 described in FIG. 3. However, for calibration purposes, a laser beam 82 is incident by the laser 56 onto a metal block 84 rather than the actual turbine. A beam splitter 86 is used to split the laser beam 82 and transmit part of it to the first photodiode 62. The first photodiode 62 then transmits this signal to the processing circuitry 64. The second photodiode 68 captures the reflected laser beam 88 and transmits it to the processing circuitry 64. Simultaneously, a thermocouple 90 also measures temperature of the metal block 84 and passes the measured signal 92 to the processing circuitry 64. The calibration is done based on the signals from first photodiode 62, second photodiode 68 and the thermocouple 90. For every temperature measurement reading from the thermocouple 90 there is one reflectance measurement reading from the second photodiode 68. The readings are stored for a range of temperatures. In one embodiment of the present invention, a graph is plotted between temperature reflectance readings and a relationship is found between the actual temperature and the reflectance from the plot. In another embodiment of the present invention, the readings are stored as a lookup table in the processing circuitry. In actual operation of the turbine as described earlier in FIG. 3, the thermocouple is not used. The reading of the reflectance then indicates actual temperature value based on the relationship determined earlier or the lookup table.

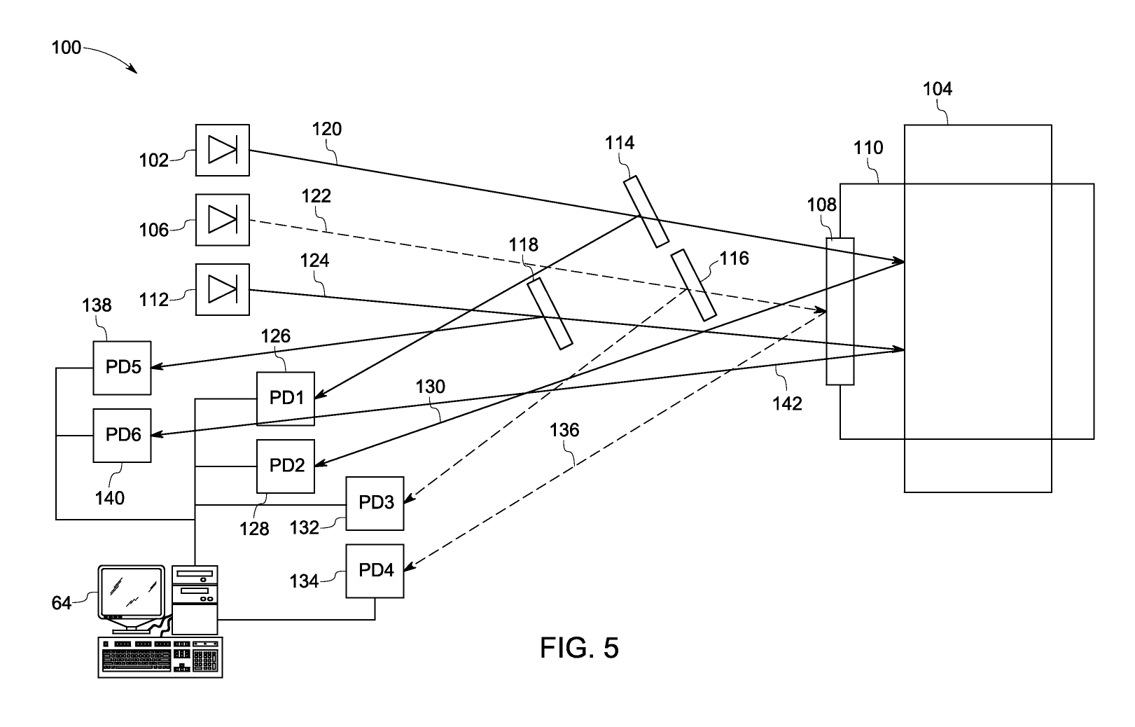

FIG. 5 is a block diagram of a temperature measurement system 100 in accordance with another embodiment of the present invention. In this embodiment, a laser 102 is used for temperature measurement of the turbine rotor surface 104. A Laser 106 is used for monitoring fouling of the window 108 of the turbine casing 110, and a laser 112 is used for monitoring fouling of the turbine rotor surface 104. Beam splitters 114, 116 and 118 are used to split the laser beams 120, 122 and 124, from the lasers 102, 106 and 112, respectively. Photodiodes 126 and 128 are used to measure the reflectance of laser beam 120 and reflected beam 130. Similarly photodiodes 132 and 134 measure the reflectance of the laser beam 122 and its reflected beam 136 from the window. It should be noted that, the laser beam 122 is targeted specifically at window for window fouling monitoring. Photodiodes 138 and 140 measure the reflectance of the laser beam 124 and the reflected beam 142. The processing circuitry 64 then performs the temperature measurement, window fouling monitoring and rotor surface fouling monitoring operations (all of which are described subsequently) based on these signals. In one embodiment, only two lasers can be used instead of three lasers 102, 106 and 112 to perform all three operations. The processing circuitry 64 determines the temperature based on the lookup table or the relationship between temperature and reflectance as described earlier. Window fouling monitoring and rotor or blade fouling monitoring is important as they affect the reflection measurements and thus actual temperature measurements. In one embodiment, the window is cleaned if the reflection from the window is found to be lower than a threshold. In another embodiment, the system 100 may also be used for measuring the temperature of a stationary object. In yet another embodiment the rotating object or the stationary object comprises periodic crystal structure.

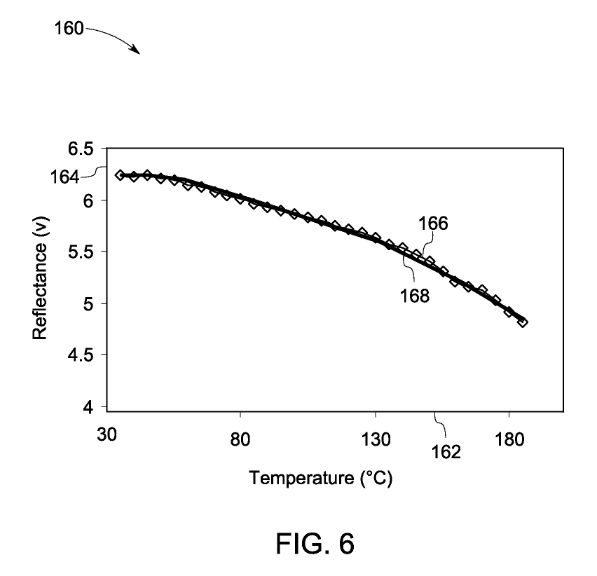

FIG. 6 is a graphical representation 160 of reflectance R versus temperature T for an aluminum body. Horizontal axis 162 represents temperature T in °C. and vertical axis 164 represents reflectance R in volts. The curve 166 is an actual plot of various data points of reflectance measured by the photodiode and the temperature sensor, whereas the curve 168 indicates trendline for the curve 166. The trendline gives an approximate polynomial relationship of order two between temperature and reflectance. In one embodiment of the present invention, the relationship may be of type such as but not limited to linear, logarithmic or exponential relationship. It can be seen from the plot that as the temperature of the aluminum body increases the measured reflectance voltage decreases. At the temperature 35° C. of the aluminum body the reflectance voltage is 6.241 volts. When the temperature of the aluminum body increases to 185° C., the reflectance voltage decreases to 4.81 volts. Thus there is 37.5% change in the reflectance from 35° C. to 185° C. The polynomial relationship for this exemplary embodiment is given by following equation:

R=−5*10⁻⁵*T²+0.0009*T+6.2561 (4);

where, R is reflectance and T is temperature.

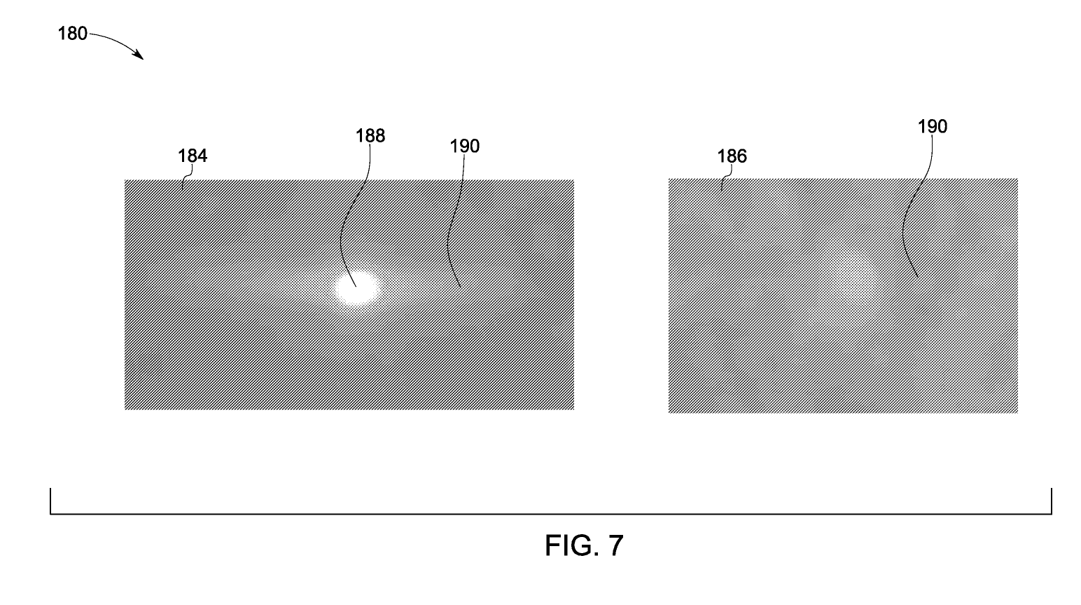

In one embodiment, the reflectance measurement from the turbine blade also depends on the type of surface where the reflectance is measured. Reflectance measured on a polished surface is much brighter than an unpolished surface. Thus, it is important to find a common region for both kinds of surfaces where there is not much variation in reflectance measurement. FIG. 7 is an illustration of reflectance 180 for the polished (image 184) as well as unpolished (image 186) surface. In one embodiment, the laser is incident onto the turbine blade. The image 184 is the image of reflection of the laser beam from the polished surface, whereas image 186 shows reflection of the laser beam from the unpolished surface. The polished surface reflection 184 shows the specular reflected spot 188 and a speckle pattern or a scatter region 190. The reflection from the unpolished surface 186 at the spot 188 is matt compared to the reflection from polished surface 184. In one exemplary experiment, it is observed that an absolute reflectance from the polished surface at spot 188 is 6.115 V and absolute reflectance from the unpolished surface is approximately 105 mV, which is a difference of a factor of 53. The absolute reflectance is the reflectance measured relative to the perfect diffuser. Speckle pattern arises due to scattering/diffractive effects from the surface arising from imperfections (surface roughness or deposits of foreign material). For the unpolished surface, these effects dominate the reflected beam. However, it is also observed that when the measurement is done in the scatter region 190 rather than at the spot 188, there is not much difference in the light intensity measurement from the polished or the unpolished surface. Thus, it is important to always measure the light intensity in the scatter region 190 rather than at the reflected spot 188.

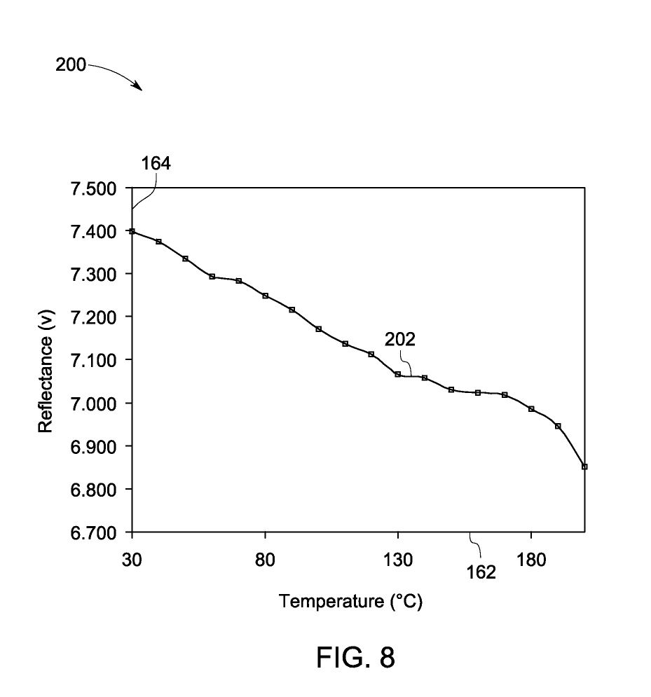

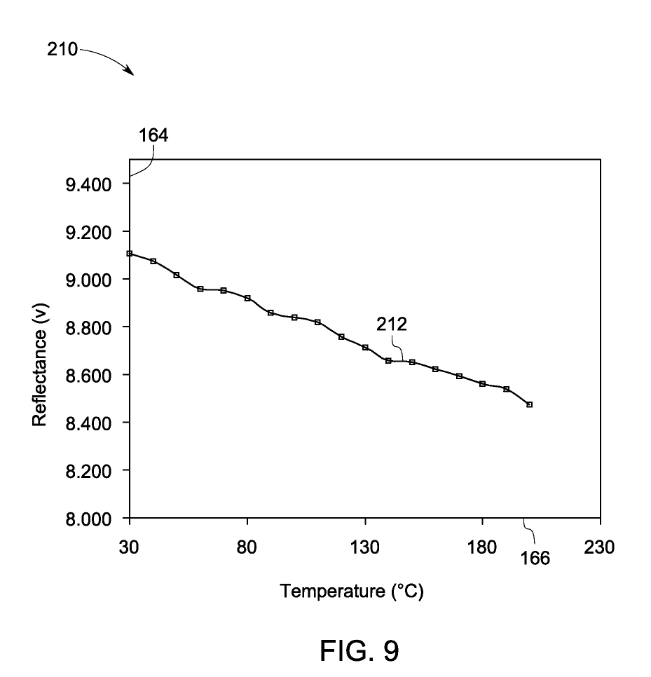

FIG. 8 and FIG. 9 are graphical representations 200, 210 of reflectance R versus temperature T for the polished and the unpolished surface respectively. As in FIG. 6, in both cases the horizontal axis 162 represents temperature T in °C. and the vertical axis 164 represents reflectance R in volts. The curve 202 is a plot of data points of reflectance measured for the unpolished surface versus temperature, and the curve 212 is a plot of data points of measured reflectance of the polished surface versus temperature. In this embodiment, the reflectance is measured for a laser beam of wavelength 633 nm and at scatter region 190. The wavelength of 633 nm is more appropriate in terms of sensitivity and reliability. However, in various embodiments, other lasers and beam characteristics may be used for monitoring reflectance and calculating temperature. The curves 202 and 212 show a decrease in measured reflectance as the temperature increases. However, the unpolished surface reflectance is 7.398 volts at 30° C. as compared to 9.108 volts for polished surface. Similarly, at a temperature of 200° C., measured reflectance for the unpolished surface is 6.851 volts compared to 8.474 volts for the polished surface. Thus, in both cases the change in reflectance or the trend is almost similar in scatter region, even though the readings are different.

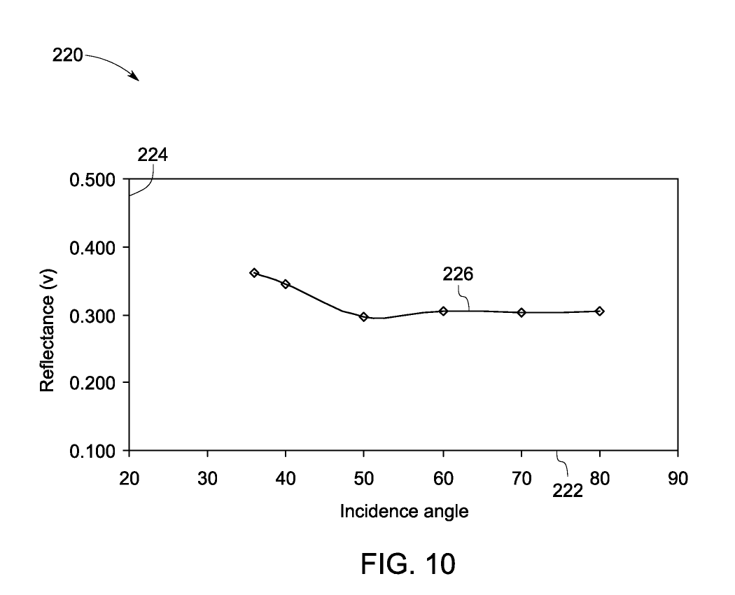

In one embodiment of the present invention, the laser beam is incident on the surface at an incidence angle based on the curvature of the rotor to improve sensitivity of reflectance measurement. FIG. 10 is a graphical representation 220 of reflectance versus angle of incidence for a polished aluminum block for an exemplary embodiment. Horizontal axis 222 represents angle of incidence in degrees and vertical axis 224 represents reflectance R in volts. The curve 226 is the plot of data points of angle of incidence and measured reflectance voltage. When the angle of incidence is 36° the measured reflectance voltage is highest and is 0.361 volts and when the angle of incidence is 80° the reflectance voltage is 0.305 volts. Thus, if the laser beam is incident at 36°, maximum sensitivity is obtained. However, it should be noted that this is just an example for a specific embodiment and the angle may be different for different embodiments. It is observed that after 36° portion of the laser beam misses the surface. So, the incidence angle based on the rotor curvature is determined upfront where the laser beam will not miss the rotor surface and also sensitivity will be highest at that angle.

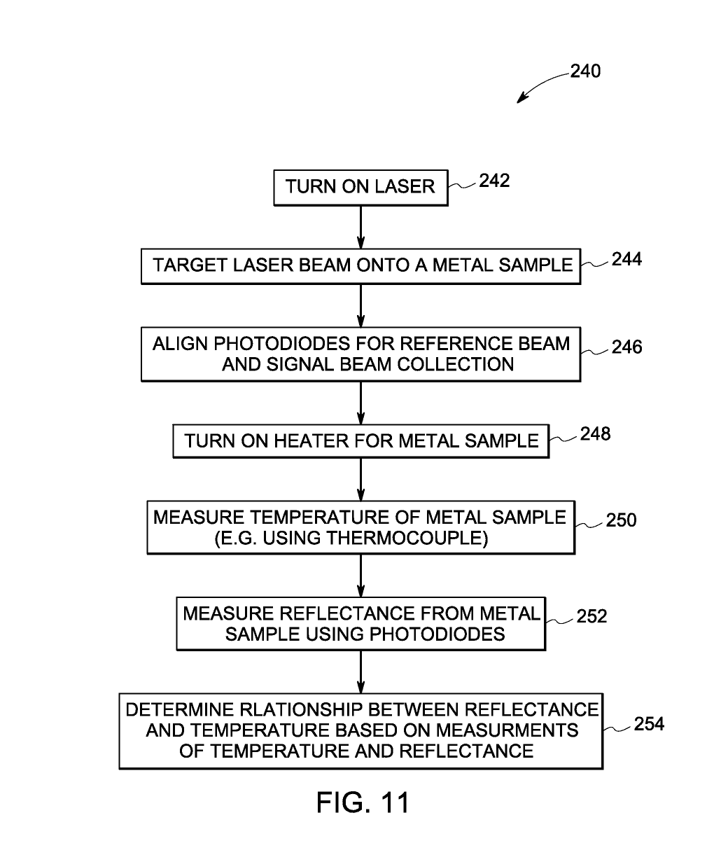

FIG. 11 is a flow chart 240 representing steps of a calibration process of a reflectance-based temperature monitoring system in accordance with an embodiment of the present invention. At step 242, the laser is turned on and then the laser beam or the reference beam is targeted onto a metal sample in step 244. At step 246, photodiodes are aligned for collection of the reference beam and the signal beam or the reflected beam. A heater is turned on to heat the metal sample at step 248. In step 250, temperature of the metal sample is measured using a thermocouple, and reflectance from the metal sample is measured using photodiodes in step 252. Lastly, in step 254, a relationship is determined between reflectance and temperature based on measurement of temperature by the thermocouple and the reflectance measured by the photodiode as explained earlier. In one embodiment, some of the steps of this flow chart such as but not limited to determining relationship between reflectance and temperature may be computer implemented, which may include suitable computer program code disposed on a computer-readable medium.

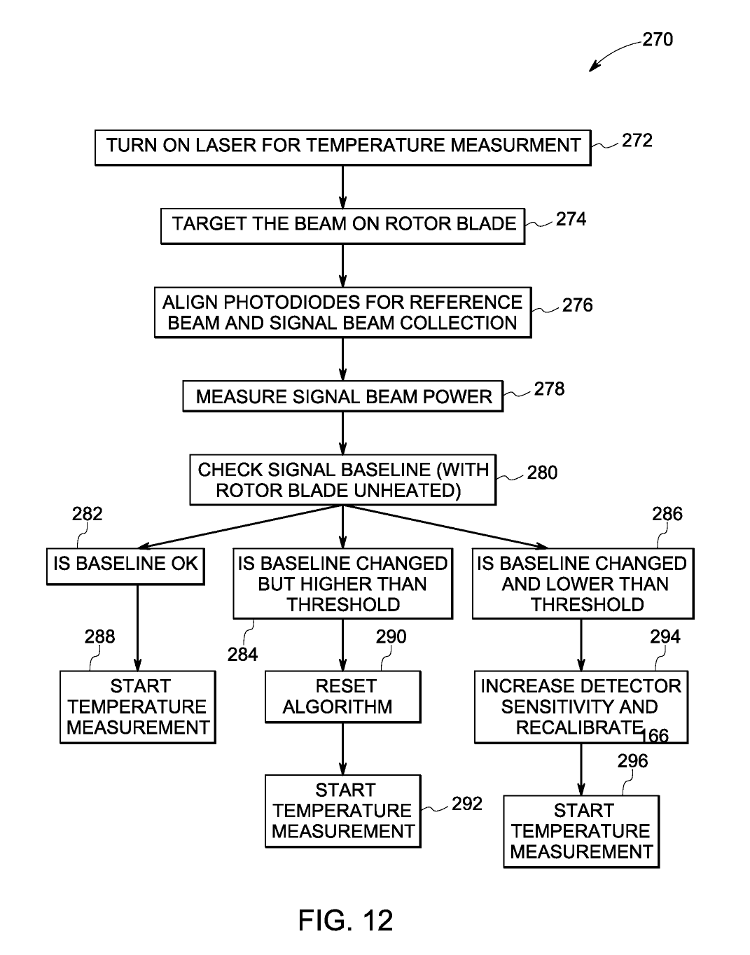

FIG. 12 is a flowchart 270 representing steps of reflectance-based temperature measurements of a metal surface in accordance with one embodiment of the present invention. A Laser is turned on for temperature measurements in step 272 and the laser beam is targeted on the rotor blade in step 274. In step 276, photodiodes are aligned for collection of the reference and the signal beam. A signal beam power is measured in step 278. In steps 280-286, it is checked whether the signal baseline is appropriate without heating the rotor blades. The signal baseline is a reference starting value of beam power. The signal beam power may change for reasons other than temperature. For an e.g., over a period of time the measured beam power may change because of change in sensitivity of the photo diode. Thus, it is important to check the signal baseline regularly. In other words, in steps 280-286 it is checked whether the signal baseline is higher than a threshold, lower than the threshold, or reasonable. If the signal baseline is reasonable, the temperature measurement is started right away in step 288. If the signal baseline is higher than threshold, then the algorithm or the flowchart 270 is reset in step 290. i.e. the new baseline value is updated and then finally the temperature measurement is started in step 292. When the signal baseline is lower than threshold, then the photo detector sensitivity is increased and it is recalibrated in step 294, and then in step 296 actual temperature measurement is started. In one embodiment, steps of this flow chart such as but not limited to determining temperature as a function of reflectance measurements from the reference beam and the signal beam may also be implemented as computer program code. A technical effect of steps represented by flow chart 270 is the indirect measurement of temperature of an object.

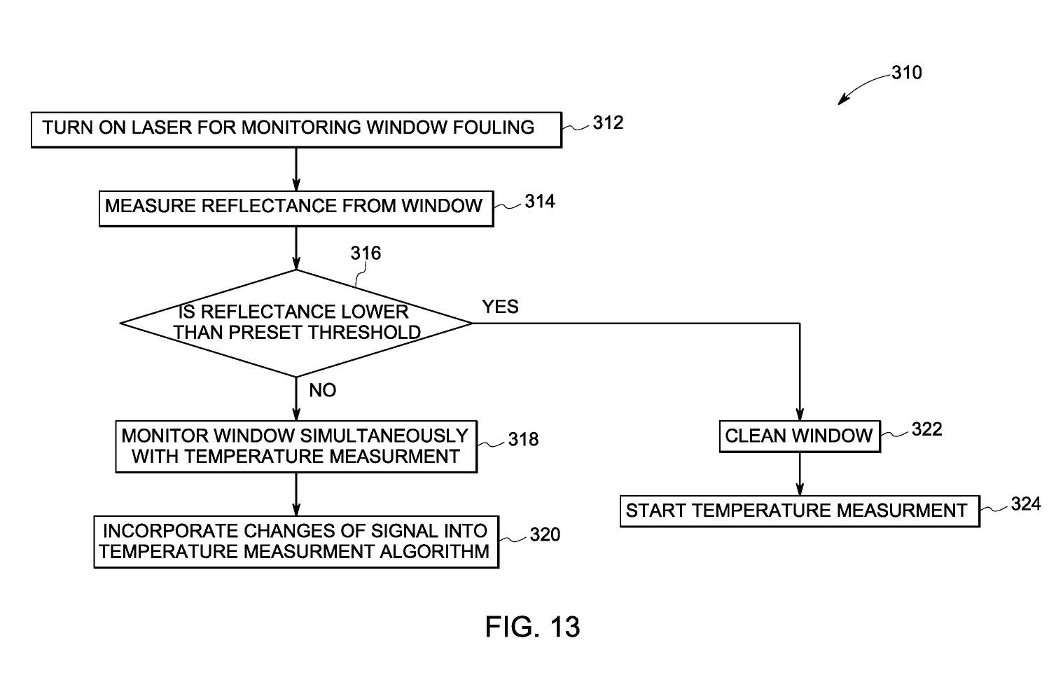

FIG. 13 is a flowchart 310 representing steps of monitoring fouling of the window. As explained earlier, monitoring window fouling is important as dust accumulated on window causes errors in temperature measurement. In step 312, laser is turned on and a laser is incident on the window surface and reflectance is measured from window in step 314. In step 316, it is checked whether the reflectance is higher or lower than the preset threshold. If the measured reflectance is lower than the preset threshold, it means dust is accumulated on window and its obstructing the reference beam or signal beam. Window is then cleaned in step 322. Actual temperature measurement is started in step 324. The temperature measurement is same as explained in FIG. 12 earlier. If the measured reflectance is not lower than the threshold, then the window is monitored simultaneously with actual temperature measurement in step 318. In step 320, the signal changes are incorporated into a temperature measurement algorithm (FIG. 12) if needed. For an e.g., if the transmittivity of the window glass changes then signal baseline may need to be changed.

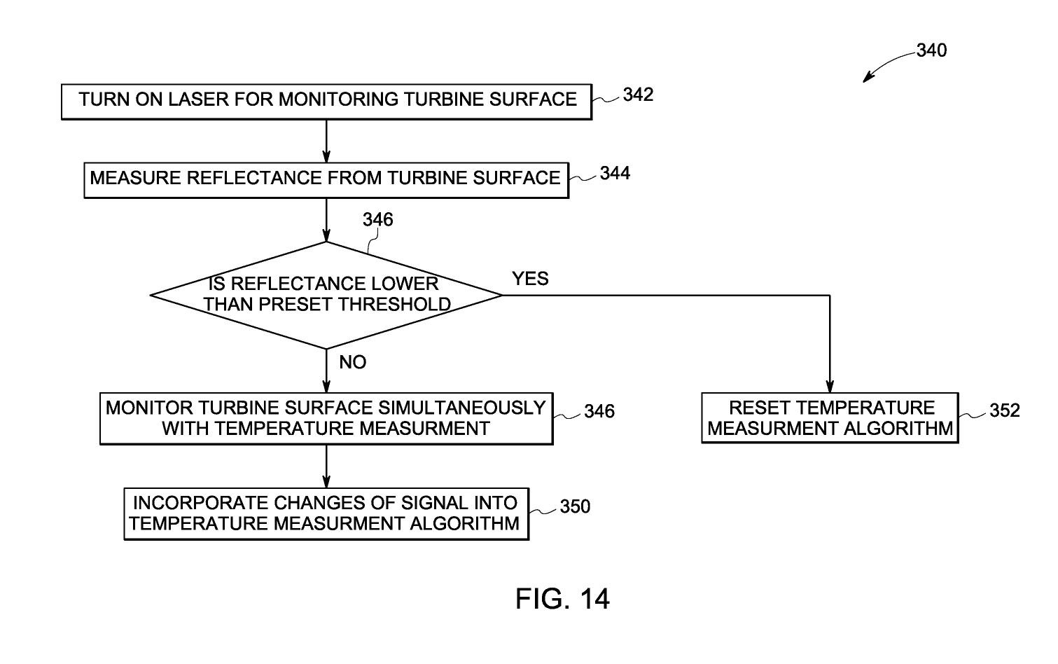

FIG. 14 is a flowchart 340 representing steps of monitoring blade fouling in accordance with an embodiment of the present invention. The steps are similar to the flowchart 310 of FIG. 13 for monitoring blade fouling. In one exemplary embodiment, first the laser is turned on in step 342, and reflectance from turbine surface or blades is measured in step 344. The decision whether reflectance is higher or lower than present threshold is taken in step 346. If the measured reflectance is lower than preset threshold, it means the blade is fouled or unclean and then the actual temperature measurement as explained in FIG. 12 earlier is started in step 352 after taking appropriate steps like cleaning the blade. If the reflectance is not lower than the preset threshold, then the blades are monitored simultaneously with temperature measurement in step 348. Any signal changes are then incorporated into temperature measurement algorithm in step 350. These signal changes may again be changing signal baseline in FIG. 12. As explained earlier for FIG. 11 and FIG. 12, some steps of FIG. 13 and FIG. 14 may be implemented as computer program code.

One embodiment of the present invention provide a non-invasive method of measuring temperature of a rotating body such as but not limited to rotor of a steam turbine. The embodiment makes use of optical reflectance to measure temperature. In one embodiment of the present invention the laser beam is modulated and the reflected beam is demodulated from the rotating body at a same frequency. This makes the rotating body to appear as stationary body to the reflectance detectors and the signal to noise ratio is significantly improved for temperature measurement. In this embodiment, the light intensity is not measured directly at the reflection spot, but in scatter region. Additionally, window fouling and blade fouling is also monitored in this embodiment.

As will be appreciated by those of ordinary skill in the art and as described earlier, the foregoing example or part of foregoing example and process steps may be implemented by suitable computer program code on a processor-based system, such as a general-purpose or special-purpose computer. It should also be noted that different implementations of the present invention may perform some or all of the steps described herein in different orders or substantially concurrently, that is, in parallel. For an e.g., monitoring the window fouling and blade fouling can be performed in parallel. The computer program code, as will be appreciated by those of ordinary skill in the art, may be stored or adapted for storage on one or more tangible, machine readable media, such as on memory chips, local or remote hard disks, optical disks (that is, CD's or DVD's), or other media, which may be accessed by a processor-based system to execute the stored code. Note that the tangible media may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for measuring temperature of a rotating body, comprising:
striking a light beam onto the rotating body;
measuring a reflectance of the light beam from the rotating body; and
obtaining a temperature of the rotating body based upon the reflectance.

2. The method of claim 1, wherein the rotating body comprises a rotor of a steam turbine or a gas turbine or an aircraft engine.

3. The method of claim 1, wherein striking the light beam onto the rotating body comprises striking the light beam at an incidence angle to improve sensitivity of reflectance measurement.

4. The method of claim 1, wherein measuring the reflectance of the light beam comprises capturing a reflected light beam from the rotating body by a photodiode.

5. The method of claim 1, wherein measuring the reflectance of the light beam comprises modulating a light source directed at the rotating body and demodulating a reflected light at a same frequency.

6. The method of claim 1, wherein measuring the reflectance of the light beam comprises measuring the light beam intensity in a scatter region.

7. The method of claim 1, wherein obtaining the temperature of the rotating body comprises calibrating a light detector configured to measure the reflectance of the light beam.

8. The method of claim 7, wherein calibrating the light detector comprises measuring temperature of a heated metal sample using a thermocouple.

9. The method of claim 7, wherein calibrating the light detector comprises measuring reflectance of an incident light beam onto the heated metal sample by the light detector.

10. The method of claim 7, wherein calibrating the light detector further comprises determining relationship between measured temperature of the heated metal sample and the measured reflectance of the light beam from the heated metal sample.

11. A turbine having a temperature measurement system, wherein the temperature measurement system comprises:
a light source configured to emit a light beam onto a rotor of the turbine;
a light detector configured to detect reflectance of the light beam from the rotor; and
a processing circuitry configured to obtain temperature based on the reflectance of the light beam.

12. The system of claim 11, wherein the light source comprises a laser beam or a light emitting diode beam.

13. The system of claim 11, wherein the light detector comprises a photodiode or a pyroelectric detector.

14. The system of claim 11, wherein the light source and the light detector are configured to monitor a fouling condition of a window of a turbine casing.

15. The system of claim 11, wherein the light source and the light detector are configured to monitor a fouling condition of one or more surfaces of the rotor of the turbine.

16. The system of claim 11, wherein the light source is oriented at an incidence angle to improve sensitivity of measurement of the reflectance.

17. The system of claim 11, wherein the processing circuitry is configured to calibrate the light detector.

18. The system of claim 11, wherein the processing circuitry is configured to determine whether the turbine casing window is fouled.

19. The system of claim 11, wherein the processing circuitry is configured to determine whether the turbine rotor surfaces are fouled.

20. A system, comprising:
a computer-readable medium comprising code for determining temperature as a function of reflectance measurement from a light beam directed toward and reflected from an object.

21. The system of claim 20, wherein the object comprises periodic crystal structure.

22. The system of claim 20, wherein the object comprises a rotating body, a curved body, or a combination thereof.

23. The system of claim 20, wherein the light beam is directed toward the object at an incidence angle to improve sensitivity of reflectance measurement.

24. The system of claim 20, wherein the reflectance measurement comprises measuring the light beam intensity in a scatter region.
